(19) United States
(12) Patent Application Publication
(10) Pub. No.: US 2005/0220599 A1
(43) Pub. Date: Oct. 6, 2005

(54) Clamshell and fork-style material handling apparatus

(76) Inventors: Matthew A. Job, Romeo, MI (US); Laxmi P. Musunur, Auburn Hills, MI (US); Richard Johnson, Rochester Hills, MI (US)

Correspondence Address: BUTZEL LONG;DOCKETING DEPARTMENT, 100 BLOOMFIELD HILLS PARKWAY, SUITE 200, BLOOMFIELD HILLS, MI, 48304, US

(21) Appl. No.: 10/817,083

(22) Filed: Apr. 2, 2004

(51) Int. Cl. B65G 1/00

(52) U.S. Cl. 414/626

(57) ABSTRACT

A material handling apparatus includes a robotic arm having a clamshell gripping mechanism depending therefrom adapted to selectively engage opposite sides of a packaging container. A fork-type loader also depends from the robotic arm. The fork-type loader is adapted to selectively support a bottom portion of the packaging container. The clamshell gripping mechanism and the fork-type loader can be used independently or in a cooperating manner to support and move the packaging container from a container to a pallet.

### BACKGROUND OF THE INVENTION

The present invention relates in general to a pick and place robotic material handling unit for picking packages from a conveyor and dropping or placing the packages on a pallet, and more specifically, to a fork/clamshell material handling unit for palletizing bundles and containers from a conveyor.

Robotic systems for unloading of various types of packages from a conveyor line typically utilize either a clamshell gripper or a fork-type support member. A clamshell gripper is a compression type gripper where force is applied to two opposite sides of a container type package to secure the container during an unloading or loading process. Clamshell grippers do not support containers from the bottom and, therefore, typically require a high amount of pressure on the sides of the container to overcome a lack of support on the bottom side of the container. Damage can occur to products packaged within the container due to the forces exerted on the sides of the container especially in cases where soft containers (e.g. cardboard) or heat-shrunk bundles are being moved.

A fork-type support member typically picks up packages from the bottom similar to a spatula, supporting the package only from the bottom thereof with either one or an opposed pair of forks. The fork-type support member is commonly used with roller conveyor systems. The forks of the fork-type support member protrude into spaces between the rollers on a typical accumulation roller conveyor to engage and pickup the package from the bottom. The fork-type support member may include a top bar or pad to apply top pressure to secure the package to avoid tipping of the package during motion of the robotic system which is especially important when moving open top containers.

Fork-type support members have issues with meeting high production rates of bulk material due to slow actuation times of the mechanical linkages. Linear motion is commonly used as a maneuver in driving the forks under the package. Typical fork-type support members require that fork lengths cover nearly 80% of the package footprint to properly support the package during the unloading and loading process. Due to the nature, length, and necessary approach positions of using linear forks for loading packages, actual loading times can take up to two seconds. Furthermore, unloading placement times can be in excess of one second due to the time needed for the linear forks to clear the bottom of the package. Additionally, because one set of grippers of a set length is not flexible to handle a wide range of package sizes, it is difficult to offer flexibility that a customer may desire in a material handling apparatus.

### SUMMARY OF THE INVENTION

The present invention has the advantage of using a fork-type support member and a clam-shell gripping mechanism in an independent or a cooperating manner to efficiently and reliably unload packages from a conveyor system and place the packages on a pallet or the like.

In one aspect of the apparatus according to the present invention, a material handling apparatus includes a robotic arm adapted for vertical and horizontal movement. A clamshell gripping mechanism depending from the robotic arm is adapted to selectively engage the sides of a package. A fork-type loader also depends from the robotic arm. The fork-type loader is adapted to selectively support the package from one side of the bottom thereof. The clamshell gripping mechanism and the fork-type loader can be used in either an independent or a cooperating manner to support and move the package.

A material handling apparatus according to the present invention for moving packages between a conveyor and a destination location includes a robotic arm having a free end, a clamshell gripper means pivotally attached to the free end of the robotic arm and extending on opposite sides of a longitudinal axis thereof, and a first moving means attached to the free end of the robotic arm and to the clamshell gripper means for moving the clamshell gripper means between a clamped position and an unclamped position. A fork-type loader is attached to the free end of the robotic arm and is positioned adjacent one side of the clamshell gripper means. A second moving means is attached to the free end of the robotic arm and to the fork-type loader for moving the fork-type loader between a pick position and an open position.

A control means is connected to the first and second moving means for selectively operating the clamshell gripper means and the fork-type loader in independent and cooperative modes whereby the clamshell gripper means engages opposite sides of a package in the clamped position and the fork-type loader supports a bottom of the package in the pick position. An adjustable “hard stop” and/or a “soft stop” can be provided to selectively limit the swing of the clamshell gripper means and the fork-type loader when desirable. The adjustable stop also can be applied to a case/bag gripper unit having opposed fork-type support members. An upper support pad and associated third moving means are attached to the free end of the robotic arm and the control means is connected to the third moving means for engaging the upper support pad with a top of the package.

### BRIEF DESCRIPTION OF THE DRAWINGS

FIG. 1 is a side elevation view of a robotic material handling unit in accordance with the present invention for the handling of packages from a conveyor system;

FIG. 2 is a front elevation view of the fork/clamshell unit shown in FIG. 1 in a pickup ready position;

FIG. 3 is a view similar to FIG. 2 with the fork/clamshell unit in an unload ready position;

FIG. 4 is a block diagram of the control for the robotic material handling unit shown in FIGS. 1-3;

FIG. 5 is a flowchart of a method in accordance with the present invention for operating the robotic material handling unit shown in FIGS. 1-4 to unload packages from a conveyor system;

FIG. 6 is a block diagram of an adjustable stop used with the fork/clamshell unit according to the present invention; and

FIG. 7 is a front elevation view of a fork-type gripper unit showing the use of the adjustable stop.

### DETAILED DESCRIPTION OF PREFERRED EMBODIMENTS

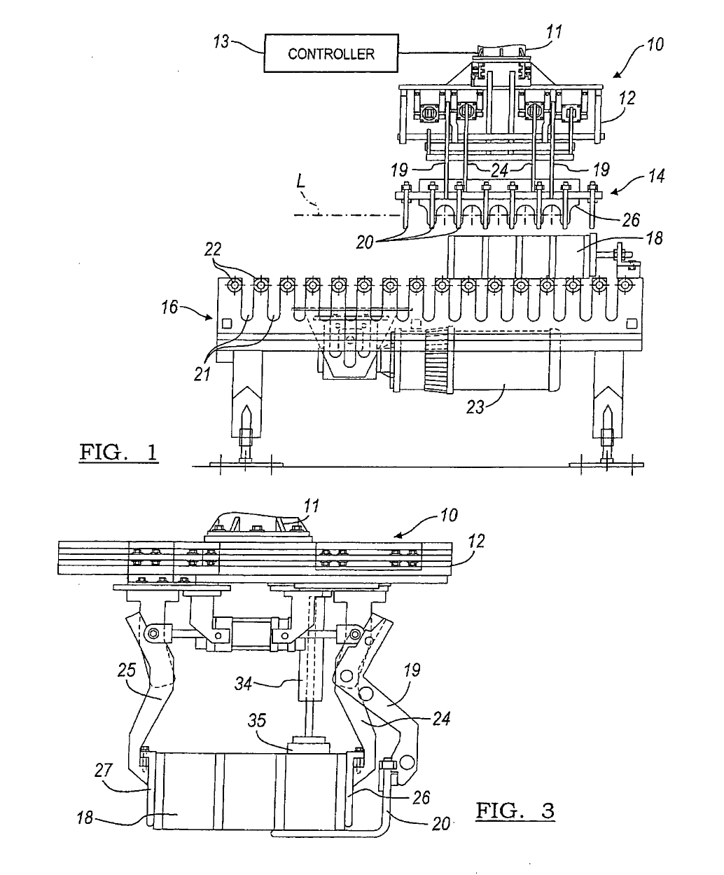

Referring now to the drawings, and particularly to FIG. 1, there is shown in side elevation a system according to the present invention for material handling a package 18, such as a container, from a conveyor system. Although a “hard” sided container is shown in the drawings, the package 18 can be “soft” sided such as a plurality of bags wrapped in plastic shrink-wrap. A conveyor 16 comprises a plurality of plurality of spaced-apart (spaces 21) transverse rollers 22 and extends longitudinally for transporting a plurality of packages 18 (only one is shown) from another location to a robotic material handling unit 10. The conveyor 16 may be motorized 23, or alternatively, the conveyor system may be a free-spinning sloped roller conveyor where the packages 18 are gravitationally transported to an unloading station.

The robotic material handling unit 10 includes a robotic arm 11, an overhead base unit 12, and a fork/clamshell unit 14. The robotic arm 11 can be a commercially available material handling robot such as the “M series” manufactured by Fanuc Robotics America, Inc. of Rochester Hills, Mich. The overhead base unit 12 depends from a free end of the robotic arm 11 and mounts the downwardly extending fork/clamshell unit 14. The robotic arm 11 connects to a controller 13 for controlling the movements of the arm 11 and the material handling operations of the fork/clamshell unit 14. The unit 14 extends about a generally horizontal longitudinal axis L parallel to a path of travel of the packages 18 (from right to left in FIG. 1) on the conveyor 16.

FIG. 2 shows the fork/clamshell unit 14 in more detail. A fork-type loader 15 depends from an underside of the base unit 12 at one side of a path of travel of the package 18. A fork-type support member 20 of the fork-type loader 15 is coupled to a spaced pair of arms 19 that move in an arc-like direction (arrow A) between an open position (counterclockwise) and a pick position (clockwise). In the preferred embodiment, the arms 19 are generally S-shaped. Alternatively, the arms 19 may be of any suitable shape. A first or upper end of each arm 19 is coupled to a first end of a first pneumatic cylinder 30 by a first coupling member 48. The first coupling member 48 includes a pin that allows pivotal movement between the first pneumatic cylinder 30 and the arms 19. An opposite end of the first pneumatic cylinder 30 is securely fastened to a pneumatic cylinder support member 46 to stabilize the first pneumatic cylinder 30 during operation.

The arms 19 are pivotably secured at an intermediate point to a first vertical support member 40 by a first pivoting member 38. The support member 40 is attached to and extends downwardly from the base unit 12. The first pivoting member 38 allows the arms 19 to be pivotably driven by the first pneumatic cylinder 30 between the open and pick positions. The fork-type support member 20 is coupled to the lower ends of the arms 19 which all are connected together for simultaneous movement.

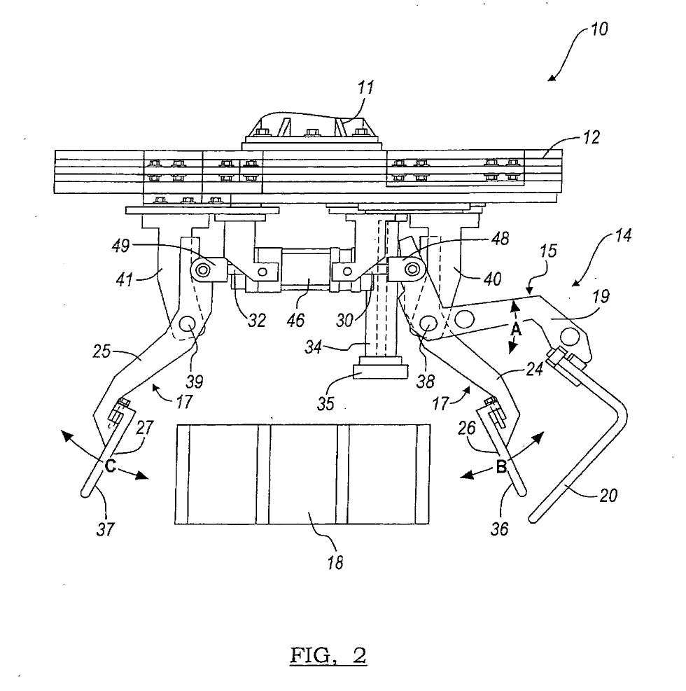

In the preferred embodiment, the fork-type support member 20 comprises a plurality of L-shaped forks (see FIG. 2). The L-shaped forks are preferably metal and have a metallic chrome finish. Alternatively, metal composites or alloys as well as other as other various finishes may be utilized. The L-shaped forks are spaced a predetermined distance apart from one another corresponding to the spacing 21 of the rollers 22. When in the pick position (FIG. 3) the fork-type support member 20 engages a bottom surface of the package 18. Each individual fork extends into a corresponding one of the plurality of spaces 21 (shown in FIG. 1). This allows the L-shaped forks 20 to engage and lift the package 18 from the bottom without interference from the plurality of rollers 22.

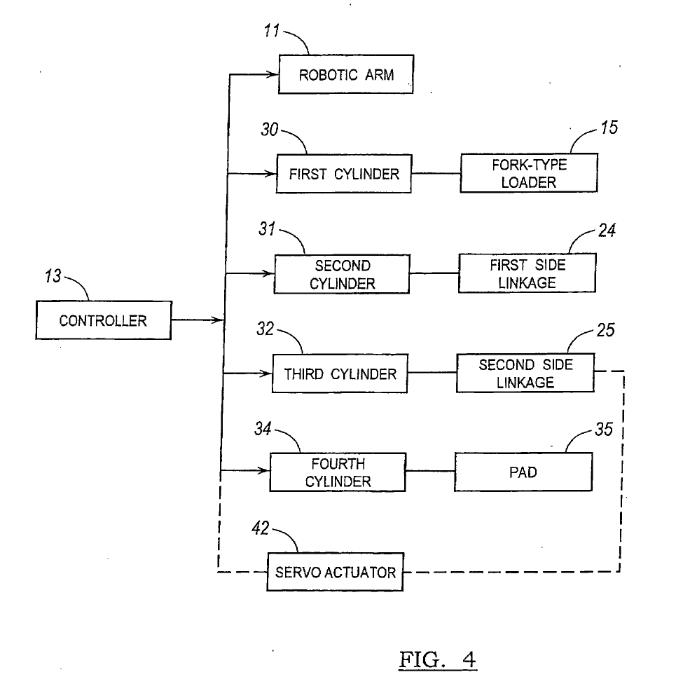

A clamshell gripper mechanism 17 of the fork/clamshell unit 14 comprises a first side support mechanical linkage 24 and a second side support mechanical linkage 25 disposed on opposite sides of the longitudinal axis L and the travel path for the package 18. Each of the linkages 24 and 25 has a pair of downwardly extending arms. As shown in FIG. 1, the arms of the first linkage 24 are positioned between the arms 19. A first or upper end of the first side support mechanical linkage 24 is coupled to a first end of a second pneumatic cylinder 31 (FIG. 4) similar to the first cylinder 30 by a second coupling member similar to the first coupling member 48. The second cylinder 31 and second coupling member are hidden behind the first cylinder 19 and the first coupling member 48 in FIG. 2. An opposite end of the second pneumatic cylinder 31 is securely fastened to the pneumatic cylinder support member 46. The first side support mechanical linkage 24 is pivotably secured to the first vertical support member 40 by the first pivoting member 38. The first pivoting member 38, disposed between the ends of each of the arms of the first side support linkage 24, allows the second pneumatic cylinder 31 to pivotably drive the arms of the linkage 24 between the open or unclamped position and the pick or clamped position along an arc B.

Likewise, a first or upper end of the second side support mechanical linkage 25 is coupled to a first end of a third pneumatic cylinder 32 by a third coupling member 49. The second linkage 25 is pivotably secured to a second vertical support member 41 by a second pivoting member 39 between the opposite ends of a pair of arms of the second linkage 25. The second pivoting member 39 allows the third pneumatic cylinder 32 to pivotably drive the second linkage 25 between the unclamped and clamped positions along an arc C.

A lower end of each of the arms of the first linkage 24 is securely fastened to a first side support plate 26. Likewise, a lower end of each of the arms of the second linkage 25 is securely fastened to a second side support plate 27. The side support plates 26 and 27 are elongated structural members extending a predetermined length and width to engage opposite sides of the package 18. In the preferred embodiment the side support plates 26 and 27 are rectangular. The bottom portions of the side support plates 26 and 27 each include a plurality of forks 36 and 37 respectively. The forks 36 and 37 extend generally vertically and are spaced apart. As the side support plates 26 and 27 engage the respective sides of the package 18, each individual fork of the side support plates 26 and 27 displaces within a corresponding one of the spaces 21 (shown in FIG. 1) of the conveyor 16 without interference from the plurality of rollers 22. This allows for increased speed when clamping the package 18 since the plurality of forks 36 and 37, and the spaces therebetween, eliminate a potential interference condition with the plurality of rollers 22. Otherwise tight tolerances and slow maneuvering would be required for transitioning the side support plates against the sides of the package 18 to fully engage the package 18 directly above the plurality of rollers 22. As the side support plates 26 and 27 transition between the unclamped and clamped position, the side support plates 26 and 27 contact opposite sides of the package 18 and apply a low predetermined compression force to the package 18. The low predetermined compression force stabilizes the package 18 while the package 18 is being unloaded from the conveyor 16 and transferred to a desired location such as a shipping pallet (not shown).

The stabilization attained by utilizing the first and second side support mechanical linkages 24 and 25 permits less than 50% of a footprint (i.e., bottom surface) of the package 18 to be supported by the fork-type support member 20. This allows for flexibility in handling a wide range of package sizes. With the combined use of the fork-type loader 15 and the clamshell gripper mechanism 17, sufficient material handling support is provided so that typical heat shrink bundles can be handled reliably and efficiently even when the heat shrink is loosely wrapped.

Furthermore, the present invention transitions the fork-type loader 15 between the open and pick positions using a swing out arc-like motion as opposed to a drop down and linear slide motion. The actuation time to transition between the unloaded and loaded positions is less than 0.25 seconds. This fast actuation time allows for containers or bundles to be loaded and unloaded at a much higher rate than conventional pick and place robotic units, and as a result, higher production rates are achieved.

Additionally, an upper support pad 35 may be utilized to provide a downward force to further secure the package 18 during motion of the robotic material handling unit 10. A fourth pneumatic cylinder 34 is attached to the base unit 12 and is used to drive the upper support pad 35 against a top surface of the package 18. The upper support pad 35 is positioned vertically inline with a portion of the fork-type support member 20 in the pick position (FIG. 3) so that a compression force may be applied to a top and bottom portion of the package 18 that is disposed between the upper support pad 35 and the fork-type support member 20. The cylinder 34 is controlled by the controller 13 to raise the pad 35 to a disengaged position (FIG. 2) and lower the pad to an engaged position (FIG. 3). The support member 20 and the pad 35 cooperate to reduce the amount of pressure required to be applied by the plates 26 and 27 in order to stabilize the package 18.

FIG. 3 illustrates the robotic material handling unit 10 in the clamped pick position. The second pneumatic cylinder 31 (not shown) and the third pneumatic cylinder 32 are actuated to drive the first and second side support linkages 24 and 25 to the clamped position. The first and second side support plates 26 and 27 are clamped against opposing sides of the package 18. At approximately the same time, the arms 19 are driven to the loaded position by the first pneumatic cylinder 30. The fork-type support member 20 engages a bottom surface of the package 18. The upper support pad 35 is driven into contact with the upper surface of the package 18 by the fourth cylinder 34 to further stabilize the package 18. The package is then picked up from the conveyor 16 and positioned over a drop location by movement of the robotic arm 11.

At a designated placement location the picking process is reversed to drop the package 18 onto, for example, a pallet. The articulating arms 19 are driven to the open position by the first pneumatic cylinder 30. The fork-type support member 20 is retracted in the arc-like motion A from the bottom surface of the package 18. The first side support mechanical linkage 24 is opened slightly to relieve pressure from the sides of the package 18. The upper support pad 35 is then retracted. The material handling unit is upwardly displaced by the robotic arm 11 to clear the package 18. Both side support linkages 24 and 25 are then fully retracted to the unclamped positions as the robotic material handling unit 10 is returned to the position over the conveyor 16 shown in FIGS. 1 and 2 to pick the next package.

FIG. 4 is a block diagram showing the control system for the robotic material-handing unit 10. The controller 13 is connected to the robotic arm 11 to selectively control the movement of the base unit 12 and attached material handling unit 14 between the conveyor 16 and a destination such as a pallet (not shown). The controller 13 is connected to each of the first 30, second 31, third 32 and fourth 34 pneumatic cylinders to actuate the fork-type loader 15, the first linkage 24, the second linkage 25 and the pad 35 respectively.

In a second preferred embodiment of the apparatus and method of operation, a servo drive unit 42 (FIG. 4) connected to the controller 13 can be utilized if packages of different known sizes are to be unloaded from the conveyor 16. Typically, clamshell gripper 17 is configured to clamp to a predetermined position to pick up uniform packages of the same dimensions. If known different width packages are transported along the conveyor 16, the robotic material handling unit would need to adjust the spacing between the side support plates 26 and 27 to accommodate the width of each package. If the width of each package is known as it transitions to the pick position along the conveyor 16, the servo drive unit 42 could adjust the first side support linkage 24 and first side support plate 26 accordingly to accommodate each known different width package.

To adjust the first side support mechanical linkage 24 laterally, the servo drive unit 42 is coupled to a linear guide mount (not shown). The first side support mechanical linkage 24 is also coupled to the linear guide mount. As the servo drive unit 42 drives the linear guide mount laterally (transverse to the longitudinal axis L), the first linkage 24 is also driven laterally either toward or away from the package 18 depending upon the package width relative to the width of the previous package. To pick a package, both of the side support mechanical linkages 24 and 25 and the fork-style support member 20 transition to the clamping and pick positions. As the first side support mechanical linkage 24 moves in an arc-like manner to the clamp position, the servo drive unit 42 simultaneously moves the first side support linkage 24 laterally to adjust to the known package width. A soft float may further be utilized with the servo drive 42. A soft float is incorporated into the software of the controller 13 of the robotic material handling unit 10. As the first side support mechanical linkage 24 transitions to the clamped position, the controller 13 senses the pressure exerted on the side of the package 18. To maintain a small amount of force on the sides of the package 18 so as only to stabilize the package 18, the controller 13 adjusts the servo drive unit 42 accordingly to apply a predetermined amount of compression force to the package 18 as required to maintain stabilization.

The servo drive unit 42 may further be used in unclamping the package 18 by laterally relieving pressure from the side of the package 18 engaged against the first side support mechanical linkage 24. After the fork-style loader 20 is retracted from the pick position toward the open position, the servo drive unit 42 laterally drives the first side support mechanical linkage 24 via the linear guide mount partially away from the package 18 to relieve the compression force. This allows the package 18 to drop vertically to the destination location without any tilting of the package. Both side support mechanical linkages 24 and 25 thereafter are fully retracted to the open positions.

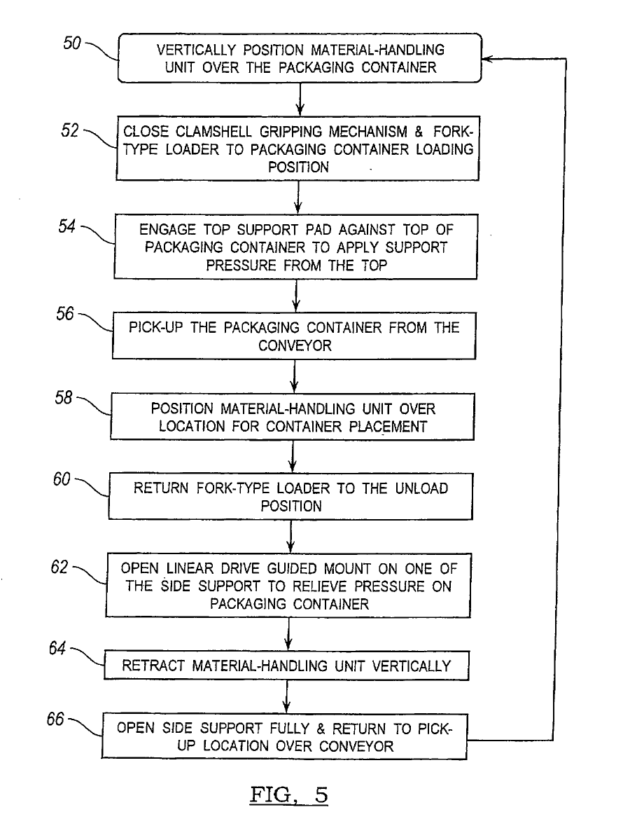

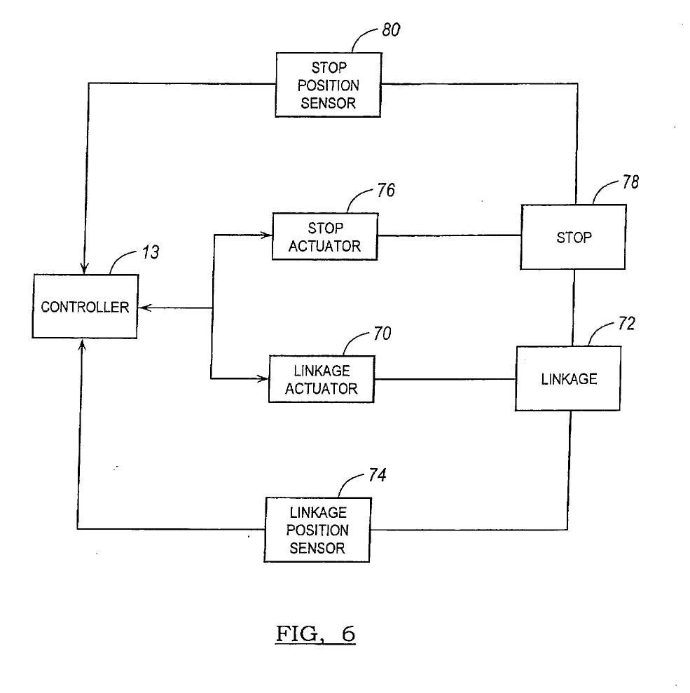

FIG. 5 illustrates a method for unloading a package from a conveyor system. In a step 50, the robotic material handling unit 10 is vertically positioned over the conveyor system. The conveyor system transports a plurality of packages 18 in sequence to an unloading station where the robotic material handling unit 10 is disposed vertically above the conveyor 16. In a step 52, the second 31 and third 32 pneumatic cylinders are actuated to drive the first 24 and second 25 support member linkages in an arc-like motion to the clamped position. As the support member linkages 24 and 25 are driven to the clamped position, the first 26 and second 27 side support plates will apply the low predetermined compression force to the opposing sides of the package 18. Simultaneously, the first pneumatic cylinder 30 drives the arms 19 into the pick position. The fork-type support member 15 will move in the arc-like motion A from the open position to the pick position and engage against a bottom surface of the package 18. Each of the L-shaped forks of the support member 20 will transition into the corresponding space 21 between the rollers 22 to engage the bottom surface of the package 18. In a step 54, the top support pad 35 is lowered to engage against a top surface of the package 18 to further stabilize the package. In a step 56, the robotic material handling unit 10 is vertically raised to pick the package 18 from the conveyor 16. In a step 58, the robotic material handling unit 10 transitions to a dedicated location for placement of the package 18. In a step 60, the first pneumatic cylinder 30 is actuated to drive the fork-type support member 15 to the open position. The fork-type support member 15 will be disengaged from the bottom surface of the package 18 with the arc-like motion A to the open position. In a step 62, the second pneumatic cylinder 31 is actuated to retract the first side support member 24 a predetermined distance from the side of the package 18 so that the first side support plate 26 slightly relieves pressure on the side of the package allowing the package to drop. In a step 64, the robotic material handling unit 10 is displaced upwardly to clear the package 18. In a step 66, the robotic material handling unit 10 is returned to the package pickup location over the conveyor 16 package picking station. During the transition from the drop or unloading location to the package pickup location, the side support members 26 and 27 are returned to the unclamped positions.

In some applications, it is desirable to limit the arcuate travel of the arm 19 and/or the linkages 24 and 25 to less than full travel. For example, two of the robotic material handing units 10 can be positioned side-by-side to unload two adjacent conveyors. By limiting the outward swing of the arm 19 and/or the linkages 24 and 25 to, for example, approximately 15°, the distance between the conveyors and the units 10 can be minimized for space savings. However, this swing limitation may cause interference with previously stacked packages when attempting to stack another package.

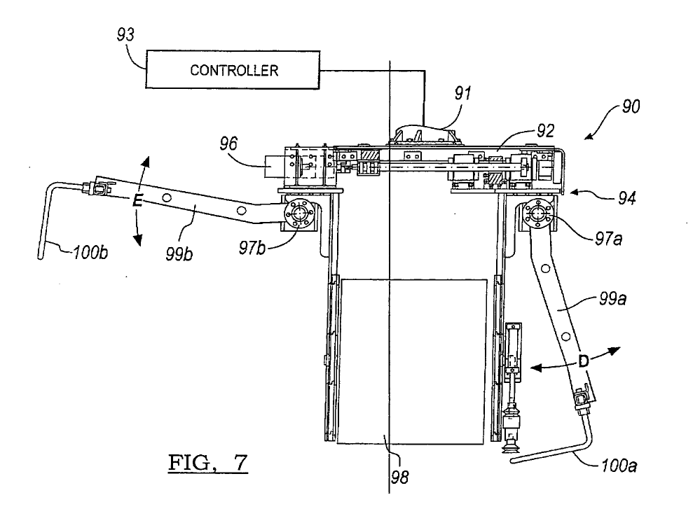

In FIG. 6, there is shown an adjustable stop system for use with the robotic material handing units 10. The controller 13 is connected to control a linkage actuator 70 which can be any of the pneumatic cylinders 30, 31 and 32. The linkage actuator 70 is connected a linkage 72 which can be the one of the arm 19 and the linkages 24 and 25 corresponding to each of the pneumatic cylinders 30, 31 and 32. A linkage position sensor 74 is connected to the controller 13 for sensing a position of the linkage 72 and providing that position data to the controller. In this manner, the controller 13 can control the linkage actuator 70 to stop the swing of the linkage 72 at any predetermined “stop” position including different positions for picking up and dropping the package. As an alternative to or combined with the sensor 74, the linkage actuator 70 can provide position feedback to the controller 13. This method of control provides an adjustable “soft stop” since no mechanical stop engages the linkage 72.

The controller 13 can be connected to control a stop actuator 76 which is connected a mechanical stop 78 for engaging one of the one of the arm 19 and the linkages 24 and 25. A stop position sensor 80 is connected to the controller 13 for sensing a position of the stop 78 and providing that position data to the controller. In this manner, the controller 13 can control the stop actuator 76 to position the stop 78 at any predetermined “stop” position including different positions for picking up and dropping the package. As an alternative to or combined with the sensor 80, the stop actuator 76 can provide position feedback to the controller 13. This method of control provides a “hard stop” since there is a mechanical stop engaging the linkage 72. The linkage position sensor 74 can be used to confirm the position of the linkage 72 to the controller 13.

The adjustable stop also can be utilized with a robotic material handling unit 90 of the conventional case/bag gripper type. The unit 90 includes a robotic arm 91, an overhead base unit 92, and a case/bag gripper unit 94. The robotic arm 91 can be like the arm 11 shown in FIGS. 1-4. The overhead base unit 92 depends from a free end of the robotic arm 91 and mounts the downwardly extending case/bag gripper unit 94. The robotic arm 91 connects to a controller 93, similar to the controller 13 of FIGS. 1 and 4, for controlling the movements of the arm 91 and the material handling operations of the case/bag gripper unit 94.

The unit 94 includes a pair of pivot points 97a and 97b at opposite sides of a path of travel of a package 98 such as a case or a bag. Each arm of a pair of associated arms 99a, 99b has an upper end rotatably attached to the respective one of the pivot points 97a, 97b for movement in an arc-like direction (arrows D and E respectively) between an open position (counterclockwise) and a pick position (clockwise). An associated fork-type support member 100a, 100b is coupled to lower ends of the arms 99a, 99b respectively. In the preferred embodiment, the fork-type support member 100a, 100b comprises a plurality of L-shaped forks (see member 20 in FIG. 2).

The arms 99a, 99b are coupled to the actuator 96 which preferably can be a pneumatic cylinder. Under the control of the controller 93, the arms can pivot to a maximum open position of approximately 100° as illustrated by the arm 99b in FIG. 7 to minimize interference with packages 98 already present when palletizing. However, one or both of the arms can be limited by the stop 78 (FIG. 6) to any selected limited open position. For example, the arm 99a is shown in a stop-limited open position at approximately 15° from vertical.

In accordance with the provisions of the patent statutes, the present invention has been described in what is considered to represent its preferred embodiment. However, it should be noted that the invention can be practiced otherwise than as specifically illustrated and described without departing from its spirit or scope.

1. An apparatus for handling packages between a pickup location and a spaced destination location, comprising:
a clamshell gripper means adapted to be attached to a robotic arm;
a first means for moving said clamshell gripper means between a clamped position and an unclamped position;
a fork-type loader adapted to be attached to the robotic arm;
a second means for moving said fork-type loader between a pick position and an open position; and
control means connected to said first and second means for moving, said control means selectively operating said clamshell gripper means and said fork-type loader in independent and cooperative modes whereby said clamshell gripper means engages opposite sides of a package in said clamped position and said fork-type loader supports a bottom of the package in said pick position.

2. The apparatus according to claim 1 including an overhead base unit adapted to be attached to the robotic arm, said clamshell gripper means and said fork-type loader being mounted on said overhead base unit.

3. The apparatus according to claim 1 wherein said clamshell gripper means further comprises a first side support mechanical linkage coupled to a first side support plate, said first side support mechanical linkage being pivoted about a first pivoting member, said first side support plate being adapted to engage one of the opposite sides of the package.

4. The apparatus according to claim 3 wherein said clamshell gripping mechanism further comprises a second side support mechanical linkage coupled to a second side support plate, said second side support mechanical linkage being pivoted about a second pivoting member, said second side support plate being adapted to engage another one of the opposite sides of the package.

5. The apparatus according to claim 4 wherein said first side support mechanical linkage and said second side support mechanical linkage are mounted to transition between said unclamped position and said clamped position in an arc-like motion.

6. The apparatus according to claim 4 including a base unit, said first and second side support linkages being pivotally mounted on said base unit for movement between said unclamped and clamped positions with an arc-like motion.

7. The apparatus according to claim 4 wherein said first means for moving includes a pair of pneumatic cylinders each connected to an associated one of said first and second side support linkages, said cylinders being connected to said control means for actuation.

8. The apparatus according to claim 1 wherein said fork-type loader includes at least one arm being pivotally mounted and having one end connected to said second means for moving and an opposite end, and a fork-type support member attached to said at least one arm opposite end for engaging and supporting the bottom of the package.

9. The apparatus according to claim 8 including a base unit, said fork-type loader being pivotally mounted on said base unit for movement between said pick and open positions with an arc-like motion.

10. The apparatus according to claim 1 wherein said second means for moving includes a pneumatic cylinder connected to said fork-type loader, said cylinder being connected to said control means for actuation.

11. The apparatus according to claim 1 including an upper support pad moveable between an engaged position for engaging an upper surface of the package and a disengaged position.

12. The apparatus according to claim 11 wherein said upper support pad is positioned above said fork-type loader when said fork-type loader is in said pick position.

13. The apparatus according to claim 11 including a pneumatic cylinder attached to said upper support pad, said cylinder being connected to said control means for actuation.

14. The apparatus according to claim 1 including at least one of a soft stop means and a hard stop means connected to said control means for selectively limiting at least one of said unclamped position and said open position to less than a full travel.

15. The apparatus according to claim 14 wherein said soft stop means controls at least one of said first and second means for moving.

16. The apparatus according to claim 14 wherein said hard stop means includes a stop for engaging one of said clamshell gripper means and said fork-type loader and a stop actuator connected to said control means for selectively moving said stop.

17. A material handling apparatus for moving packages between a conveyor and a destination location, comprising:
a robotic arm having a free end;
a clamshell gripper means pivotally attached to said free end of said robotic arm and extending on opposite sides of a longitudinal axis thereof;
a first moving means attached to said free end of said robotic arm and to said clamshell gripper means for moving said clamshell gripper means between a clamped position and an unclamped position;
a fork-type loader attached to said free end of said robotic arm and being positioned adjacent one side of said clamshell gripper means;
a second moving means attached to said free end of said robotic arm and to said fork-type loader for moving said fork-type loader between a pick position and an open position; and
control means connected to said first and second moving means for selectively operating said clamshell gripper means and said fork-type loader in 30 independent and cooperative modes whereby said clamshell gripper means engages opposite sides of a package in said clamped position and said fork-type loader supports a bottom of the package in said pick position.

18. The apparatus according to claim 17 including at least one of a soft stop means and a hard stop means connected to said control means for selectively limiting at least one of said unclamped position and said open position to less than a full travel.

19. The apparatus according to claim 17 including an upper support pad attached to said free end of said robotic arm and a third moving means attached to said free end of said robotic arm and said upper support pad, said third moving means being connected to said control means for moving said upper support pad between an engaged position for engaging an upper surface of the package and a disengaged position.

20. The apparatus according to claim 17 wherein said clamshell gripper means includes a pair of side linkages positioned on opposite sides of said longitudinal axis, at least one of said side linkages being movable transverse to said longitudinal axis, and an actuator means connected between said at least one of said side linkages and said free end of said robotic arm for moving said at least one of said side linkages relative to another one of said side linkages to adjust a spacing between said side linkages in said clamped position.

21. An apparatus for handling packages between a pickup location and a spaced destination location, comprising:
a gripper unit adapted to be attached to a robotic arm, said gripper unit having opposed arms with fork-type support members;
an actuator means coupled to said arms for moving said fork-type support members between a pick position and a maximum open position; and
an adjustable stop actuator for selectively limiting movement of at least one of said arms to a limited open position different than said maximum open position.

22. The apparatus according to claim 21 including control means connected to said actuator means for selecting said limited open position.

23. A method of operating a material handling apparatus for moving packages comprising the steps of:
a) providing a clamshell gripper means having a pair of side linkages and pivotally mounting the side linkages on opposite sides of a longitudinal axis for movement between a clamped position and an unclamped position;
b) providing a fork-type loader and pivotally mounting the fork-type loader adjacent one of the side linkages for movement between an open position and a pick position;
c) providing an upper support pad for movement between a disengaged position and an engaged position; and
d) moving the clamshell gripper to the clamped position and into engagement with opposed sides of a package;
e) moving the fork-type loader to the pick position and into engagement with a bottom of the package; and
f) moving the upper support pad to the engaged position and into engagement with a top of the package whereby the package is stabilized for movement.

24. The method according to claim 23 including steps of: g) moving the package to a destination location; h) moving the fork-type loader from the pick position to the open position; i) moving at least one of the side linkages slightly away from the clamped position; j) moving the upper support pad from the engaged position to the disengaged position to release the package; and k) moving the side linkages to the unclamped position.

25. The method according to claim 24 wherein said step i) is performed by moving the at least one of the side linkages slightly away from the clamped position in an arc-like motion.

26. The method according to claim 24 wherein said step i) is performed by moving the at least one of the side linkages slightly away from the clamped position in a generally horizontal motion.
